(19) United States
(12) Patent Application Publication
(10) Pub. No.: US 2024/0339019 A1
(43) Pub. Date: Oct. 10, 2024

(54) SYSTEM, ELECTRICAL SOCKET DEVICE AND METHOD FOR MONITORING USAGE OF AN ELECTRICAL APPLIANCE

(71) Applicant: UEC System Solutions Corporation, Taipei City (TW)

(72) Inventors: Hui-Ming PAN, Taipei City (TW); Hsiu-Ping CHOU, Taipei City (TW); Hung-Yao WU, Taipei City (TW); Hsin-Yu LI, Taipei City (TW); Chun-Yu MAK, Taipei City (TW)

(21) Appl. No.: 18/749,307

(22) Filed: Jun. 20, 2024

Related U.S. Application Data
(63) Continuation-in-part of application No. 17/491,037, filed on Sep. 30, 2021.

(30) Foreign Application Priority Data
Oct. 22, 2020 (TW) 109136687

(51) Int. Cl. G08B 21/04

(52) U.S. Cl. CPC G08B 21/0423; G08B 21/0461; G08B 21/0469; G08B 21/0484; G08B 21/0492

(57) ABSTRACT

A system for monitoring usage of an electrical appliance includes an electrical socket device and a server. The electrical socket device includes an audio receiving module for generating an audio result based on sound at a site where the electrical appliance is disposed, and a processing module configured to generate audio feature data based on the audio result and to generate event data that is related to the usage of the electrical appliance at least based on the audio feature data. The server stores a behavioral feature recognition model that is configured to recognize multiple behavioral features related to behaviors of the user using the electrical appliance. The server uses the behavioral feature recognition model to determine whether the event data matches one of the behavioral feature, and sends a warning message to a user end device when the event data does not match any of the behavioral features.

### CROSS-REFERENCE TO RELATED APPLICATION

This is a continuation-in-part application of U.S. patent application Ser. No. 17/491,037, filed on Sep. 30, 2021, which claims priority to Taiwanese Invention Patent Application No. 109136687, filed on Oct. 22, 2020. The aforesaid application is incorporated by reference herein in their entirety.

### FIELD

The disclosure relates to a monitoring system, an electrical socket device and a method for monitoring usage of an electrical appliance.

### BACKGROUND

As the average life span of people increases, the proportion of elderly citizens in a population increases year by year. Senior citizens who are in good health, have the ability to take care of themselves and put emphasis on maintaining the privacy of their personal lives, often choose to live by themselves. However, people's memory, perception, and motor abilities will gradually decline with age, thereby increasing the probability of accidents such as falls and improper use of electrical appliances in the homes of senior citizens living alone. Furthermore, in the case that the senior citizens are living alone, when accidents do happen, there is usually no way for relevant people such as relatives, friends, or staff of nursing institutions to be notified immediately so that care and follow-up assistance and treatment may be provided.

Therefore, how to effectively remotely predict daily life routines of users is important.

### SUMMARY

Therefore, an object of the disclosure is to provide a system, an electrical socket device and a method for monitoring usage of an electrical appliance that can alleviate at least one of the drawbacks of the prior art.

According to a first aspect of the disclosure, the system for monitoring usage of an electrical appliance includes an electrical socket device and a management server. The electrical socket device includes a socket module, a storage module, a current detecting module, an audio receiving module and a processing module. The management server includes a database, a storage unit and a processing unit.

The socket module is adapted to be electrically connected to the electrical appliance, and is operable to switch between a first state for permitting supply of electric power to the electrical appliance and a second state for terminating supply of electric power to the electrical appliance. The storage module stores current feature data that is related to multiple reference values of an operating current of the electrical appliance. The reference values correspond respectively to different operating modes of the electrical appliance. The current detecting module is electrically connected to the socket module, and is configured to continuously detect a current flowing through the electrical appliance so as to generate a current detection result. The audio receiving module receives sound at the site where the electrical appliance is disposed and generates an audio result based on the sound thus received. The processing module is electrically connected to the socket module, the storage module, the current detecting module and the audio receiving module. The processing module is configured to generate audio feature data based on the audio result, and to generate event data that is related to the usage of the electrical appliance based on the current feature data, the current detection result and the audio feature data.

The database of the management server stores user data that is related to a user at the site, appliance data that is related to the electrical appliance, and service record data that is related to historical usage of the electrical appliance. The storage unit of the management server stores a behavioral feature recognition model that is configured to recognize multiple behavioral features related to behaviors of the user using the electrical appliance. The behavioral features and the behavioral feature recognition model are derived and established by using a first machine learning algorithm to analyze the user data and the service record data based on multiple feature parameters that are each related to the user, the electrical appliance, and an environment where the electrical appliance is disposed. The processing unit of the management server is communicatively connected to the processing module of the electrical socket device, and is electrically connected to the database and the storage unit. The processing module transmits the event data to the processing unit, and the processing unit uses the behavioral feature recognition model to determine whether the event data received from the processing module matches one of the behavioral features, and sends a warning message to a user end device that is related to the user upon determining that the event data does not match any of the behavioral features.

According to a second aspect of the disclosure, the method for monitoring usage of an electrical appliance is implemented by the above-mentioned system.

The method for monitoring usage of the electrical appliance includes: by the electrical socket device, continuously detecting a current flowing through the electrical appliance to generate a current detection result, receiving sound at the site, and generating an audio result based on the sound thus received; by the electrical socket device, generating audio feature data based on the audio result, generating event data related to the usage of the electrical appliance based on the current feature data, the current detection result and the audio feature data, and transmitting the event data to the management server; by the management server, using the behavioral feature recognition model to determine whether the event data received from the electrical socket device matches one of the behavioral features; and by the management server, sending a warning message to a user end device that is related to the user in response to determining that the event data does not match any of the behavioral features.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an embodiment of a system for monitoring usage of an electrical appliance according to the disclosure.

FIG. 2 is a flow chart illustrating a method to be implemented by the system for monitoring usage of an electrical appliance according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

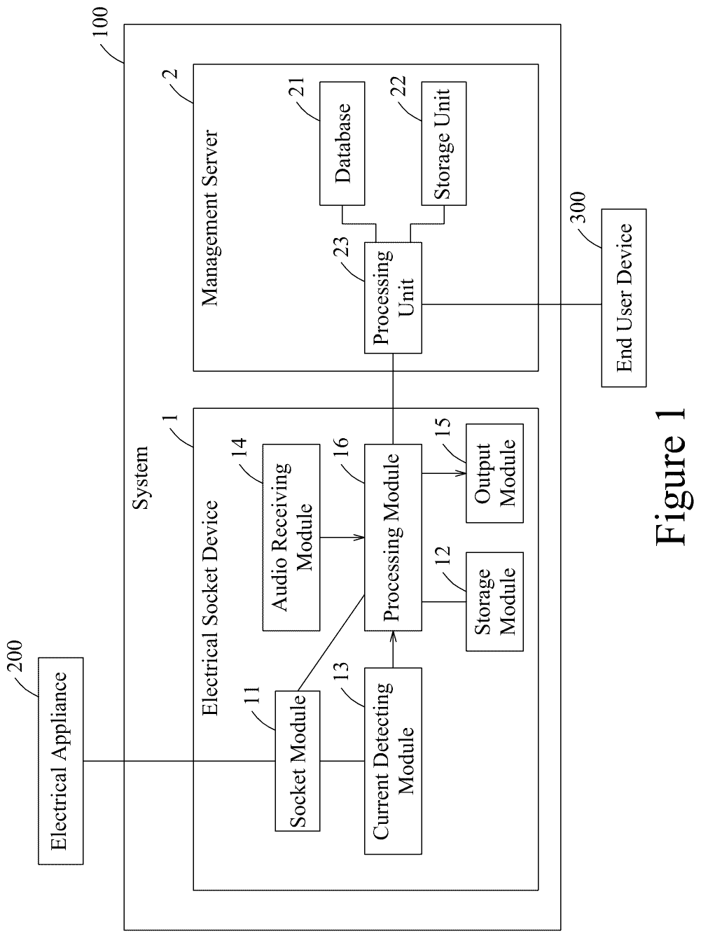

Referring to FIG. 1, a system 100 for monitoring usage of at least one electrical appliance 200 according to an embodiment of this disclosure is provided. The system 100 includes at least one electrical socket device 1 and a management server 2. The at least one electrical appliance 200 and the at least one electrical socket device 1 are used in a one-to-one configuration; that is to say, a number of the at least one electrical socket device 1 should be equal to a number of the at least one electrical appliance 200 that is to be monitored, and the at least one electrical appliance 200 corresponds respectively to the at least one electrical socket device 1. The at least one electrical appliance 200 may be used in a site, for example, a house.

Each of the at least one electrical socket device 1 includes a socket module 11, a storage module 12, a current detecting module 13, an audio receiving module 14, an output module 15, and a processing module 16. Hereinafter, only one electrical socket device 1 and one electrical appliance 200 corresponding thereto will be described in further detail for the sake of brevity.

The socket module 11 is adapted to be electrically connected to the electrical appliance 200, and is operable to switch between a first state for permitting supply of electric power to the electrical appliance 200 and a second state for terminating supply of electric power to the electrical appliance 200. In particular, the electrical socket device 1 is adapted to be electrically connected to the electrical appliance 200 corresponding thereto. The electrical appliance 200 may be exemplified as a refrigerator, a rice cooker, etc., and not limited to such. In some embodiments, the socket module 11 may be designed to include a pin portion (not shown) and a slot portion (not shown), the pin portion is adapted to be plugged into a power socket (i.e., an AC power socket existing at the house) (not shown) that is connected to a power grid (not shown), and the slot portion allows prongs of a power plug (not shown) of the electrical appliance 200 to be inserted therein. In such embodiments, the socket module 11 obtains electrical power from the power grid through the power socket, but is not limited to such. In other embodiments, the socket module 11 may be directly connected to the power grid (i.e., the socket module 11 is fixed, for example, on an internal wall of the house for replacing the power socket), and the abovementioned pin portion may be omitted. The socket module 11 may operate in the first state by a user manually connecting the electrical appliance 200 to the socket module 11 (i.e., by plugging in the power plug of the electrical appliance 200 into the socket module 11), and operate in the second state by a user manually disconnecting the electrical appliance 200 with the socket module 11 (i.e., by unplugging the power plug of the electrical appliance 200 from the socket module 11). In another example, the socket module 11 may include a switch unit (e.g., a power switch) (not shown) that is operable for the socket module 11 to switch between the first state and the second state.

The current detecting module 13 is electrically connected to the socket module 11, and is configured to continuously detect a current flowing through the electrical appliance 200 so as to generate a current detection result. In some embodiments, the current detecting module 13 may be realized using a current sensor integrated circuit (IC), Hall effect sensors, shunt resistors, and so on, but this disclosure is not limited in this respect. The audio receiving module 14 is disposed for receiving sound at the house where the electrical appliance 200 is disposed and for generating an audio result based on the sound thus received. In some embodiments, the audio receiving module 14 may be realized using a microphone, a vibration sensor, a resonant sensor, and so on, but this disclosure is not limited in this respect. The output module 15 is used for generating a perceivable output (e.g., visual output or audible output). For example, the output module 15 may include a light emitting diode (LED) device (not shown) for generating a visual output, and/or a buzzer (not shown) for generating an audible output, but this disclosure is not limited in this respect.

The storage module 12 stores current feature data that is related to multiple reference values of an operating current (reference operating current values) of the electrical appliance 200, where the reference values correspond to different operating modes of the electrical appliance 200. In this embodiment, the storage module 12 further stores a house identifier that uniquely corresponds to the house. In practice, the storage module 12 may acquire the house identifier and the current feature data through input from or download by a user operating a software application the first time the user uses the system or during a registration stage of the system. The current feature data may include, for example, a type and/or a model of the electrical appliance 200, the reference operating current values (or reference current threshold values) that correspond respectively to different operating modes, reference operating current ranges, etc. In one example, assuming that the electric appliance 200 is a refrigerator having a reference operating current value of 30 mA when operating in a general power saving mode (i.e., one of the different operating modes), a reference operating current value of 130 mA when a door of a refrigerating chamber is open (i.e., another one of the different operating modes), and a reference operating current value of 1500 mA when the compressor is operating (i.e., another one of the different operating modes), the reference operating current range may be 30 mA to 1500 mA.

The storage module 12 further stores an audio feature recognition model that is configured to recognize multiple audio features. The audio features and the audio feature recognition model are derived and established by using a first machine learning algorithm (e.g., a neural network regression algorithm, but not limited to such) to analyze the audio result based on multiple audio parameters that are each related to the environment where the electrical socket device 1 is disposed. More specifically, the audio result generated by the audio receiving module 14 includes a voltage signal that represents the sound received by the audio receiving module 14, and a time point when the sound is received by the audio receiving module 14. Each of the audio features recognized by the audio feature recognition model may include the time point, a sound duration of the sound, a sound amplitude, and an event that is related to the sound. It should be noted that, the management server 2 may be communicatively connected to the processing module 16 in order to transmit at least one audio parameter (e.g., time, amplitude, etc.) to the processing module 16, so that the processing module 16 may update the audio feature recognition model through training and making fine-tuning on the audio feature recognition model according to the at least one audio parameter.

The processing module 16 is electrically connected to the socket module 11, the storage module 12, the current detecting module 13, the audio receiving module 14 and the output module 15. The processing module 16 will be further described in detail later in this disclosure.

The management server 2 includes a database 21, a storage unit 22, and a processing unit 23 that is electrically connected to the database 21 and the storage unit 22 and that is communicatively connected to the processing module 16 of the electrical socket device 1. For example, the management server 2 may be realized as a single computer or a computer system constituted by multiple computers. In some embodiments, the management server 2 is a cloud server communicating with the processing module 16 through a network.

The database 21 stores user data that is related to one or more users who lives in the house (i.e., the site in this embodiment) and is expected to use the electrical appliance 200 (hereinafter referred to as “target user”), appliance data that is related to the electrical appliance 200, and service record data that is related to historical usage of the electrical appliance 200. In other words, if the system 100 is used to monitor multiple electrical appliances in the house, the database 21 may store multiple pieces of appliance data that correspond respectively with the electrical appliances in the house, and multiple pieces of service record data that correspond respectively with the electrical appliances in the house. For each electrical appliance, the appliance data may include, for example, the type of the electrical appliance, the model of the electrical appliance, the reference operating current ranges that correspond respectively to different operating modes of the electrical appliance (e.g., reference operating current ranges that are collected and derived from a large number of electrical appliances of the same type and of the same model). For each electrical appliance, the service record data may include, for example, information related to each use in each day (e.g., the audio features that correspond with the surrounding sound, time of use (time of using the electrical appliance 200), operating mode(s), usage duration (a length of time the electrical appliance 200 is being used in one go), etc.) within a predetermined time period in the past, and total usage duration for each day within the predetermined time period in the past, etc. The user data for each target user may include, for example, gender and age of the target user, a geographic region and/or location where the house is located, the house identifier, contact information of one or more user end devices 300 (only one is shown in FIG. 1) that are related to the target user. The contact information may be, for example, a phone number of a family member of the target user, a friend of the target user, an emergency contact person or a staff at a nursing institution of the target user, etc. The user end device 300 can be, for example but not limited to, a smartphone, a tablet computer, a notebook computer, a desktop computer, etc.

The storage unit 22 stores a behavioral feature recognition model that is configured to recognize multiple behavioral features related to behaviors of the target user using the electrical appliance 200. In this embodiment, with respect to each electrical appliance 200, the processing unit 23 uses a second machine learning algorithm (e.g., a neural network regression algorithm, but not limited to such) to analyze the user data and the service record data based on multiple feature parameters that are each related to the user(s), the electrical appliance 200, and an environment where the electrical appliance 200 is disposed (e.g., the gender and age of the user(s), the geographic region where the house is located, the type and characteristics of the electrical appliance 200, the time of use, the usage duration(s), the total usage duration for that day, the audio features of sound in the environment, etc.), so as to derive multiple behavioral features in relation to behaviors of the target user using the electrical appliance 200 and establish the behavioral feature recognition model. The database 21, storage unit 22 and/or the storage module 12 may be implemented using a non-volatile storage medium such as a hard disk drive, a solid state drive, a flash memory module, etc.

The processing module 16 and/or the processing unit 23 may include, but not limited to, at least one of, a multi-core processor, a dual-core mobile phone processor, a microprocessor, a digital signal processor (DSP), a field programmable gate array (FPGA), an application special integrated circuit (ASIC) and a radio frequency integrated circuit (RFIC). The processing module 16 and/or the processing unit 23 may further include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G), the fourth generation (4G) or the fifth generation (5G) of wireless mobile telecommunications technology, or the like.

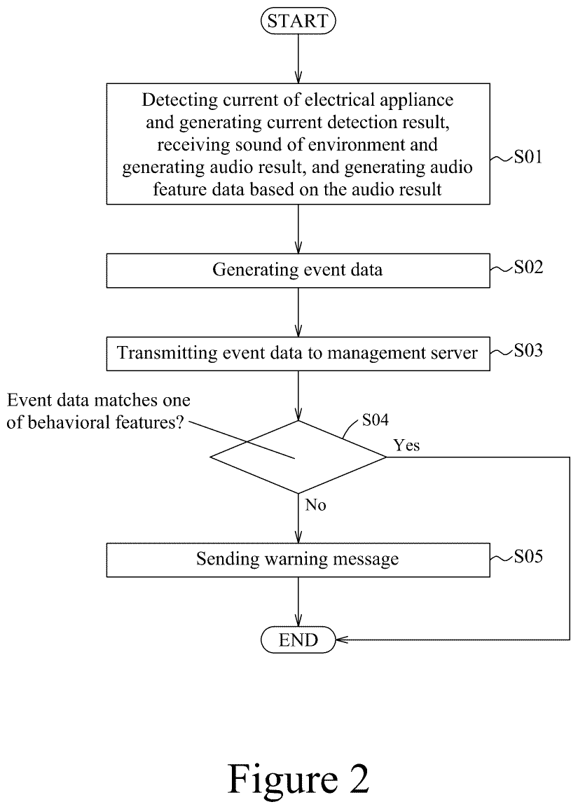

Referring to FIG. 2, a method for monitoring usage of the electrical appliance 200 to be implemented by the system 100 according to an embodiment of this disclosure is provided.

In step S01, the current detecting module 13 continuously detects a current flowing through the electrical appliance 200 to generate and transmit a current detection result to the processing module 16. The current detection result includes an actual operating current value of the electrical appliance 200. At the same time, the audio receiving module 14 continuously receives sound in the house, and generates and transmits an audio result based on the sound thus received to the processing module 16. The processing module 16 then generates audio feature data based on the audio result. In this embodiment, the processing module 16 uses the audio feature recognition model to determine which of the audio features that the audio result generated by the audio receiving module 14 matches, and generates the audio feature data based on the audio result that matches any of the audio features. That is to say, the processing module 16 uses the audio feature recognition model to determine whether there is at least one recurring and identical or similar (i.e., a predetermined degree of similarity) audio result that matches any one of the audio features. For example, for an event where the electrical appliance 200 that is a hot water dispenser is used by the target user to dispense hot water at 3 o'clock in the afternoon for 15 seconds and the event produces a sound of 50 dB received by the audio receiving module 14, the audio feature data thus generated by the processing module 16 may include data of “electrical appliance 200”=hot water dispenser, “time point”=15:00, “sound duration”=15 seconds, and “sound amplitude”=50 dB. Specifically, the time point can be regarded as a time of using the hot water dispenser, and the sound duration can be regarded as a usage duration of time the hot water dispenser is being used this time.

In step S02, for each of a plurality of specific time periods (which may be determined or changed based on practical circumstances), the processing module 16 generates event data related to the usage of the electrical appliance 200 based on the current feature data, and the current detection result and the audio feature data that are, for example, within the specific time period. That is to say, the event data may be continuously generated for each of the specific time periods. The event data may include, for example but not limited to, the house identifier, the type and model of the electrical appliance 200, a time of beginning to operate the electrical appliance 200 in each operating mode, the actual operating current value and the usage duration of the electrical appliance 200, and the audio feature data that corresponds to the sound received by the audio receiving module 14 in the house.

In step S03, the processing module 16 transmits the event data to the processing unit 23 of the management server 2 through, for example, a communication network.

In step S04, the processing unit 23 uses the behavioral feature recognition model to determine whether the event data received from the processing module 16 matches one of the behavioral features. The flow ends when the determination made in S04 is affirmative, and the flow goes to step S05 when otherwise.

In this embodiment, the processing unit 23 further stores the event data in the database 21 as a part of the service record data that corresponds with the electrical appliance 200 upon receipt of the event data. Then, the processing unit 23 may analyze the service record data to derive behavioral features that may be the same or different from the behavioral features that have been recognized by the behavioral feature recognition model so that when there are changes in behavior(s) of the user(s) in relation to using the electrical appliance 200, the processing unit 23 may update the behavioral feature recognition model in a predetermined period (e.g., once in few days or weeks). By updating the behavioral feature recognition model constantly, the processing unit 23 may be more accurate in making determination when using the behavioral feature recognition model to determine whether the event data received from the processing module 16 matches one of the behavioral features. Besides that, the processing unit 23 may determine whether operating current information that is related to the operating current of the electrical appliance 200 needs to be adjusted based on the event data and the appliance data. The processing unit 23, in response to determining that the operating current information needs to be adjusted, generates current feature adjustment data that indicates adjustment of the operating current information, and transmits the current feature adjustment data to the storage module 12 of the electrical socket device 1. The storage module 12, upon receipt of the current feature adjustment data from the processing unit 23, updates the current feature data using the current feature adjustment data.

In step S05, when the processing unit 23 determines that the event data does not match any of the behavioral features, the processing unit 23 sends a warning message to the user end device 300 that is related to the target user, and the flow ends. In particular, when the processing unit 23 determines that the event data does not match any of the behavioral features, it can be derived that the target user has abnormal behavior in relation to using the electrical appliance 200. For example, assuming that the electrical appliance 200 is a refrigerator, the event data may be determined as not matching any of the behavioral features when the event data indicates that all of the doors of the refrigerating chamber and the freezer chamber of the refrigerator have not been opened in a single day, and such a behavior in using the refrigerator will thus be determined to be abnormal. In another example, assuming that the electrical appliance 200 is an electric water boiler, the event data may be determined as not matching any of the behavioral features when the event data indicates that the electric water boiler has not been operated to dispense water in a single day, and such a behavior in using the electric water boiler will thus be determined to be abnormal. It should be noted that, due to the fact that the electric water boiler needs to keep the water warm for a long time, the actual operating current value of the electric water boiler will often be continuously maintained at a relatively high current state, and it might be difficult to determine a usage behavior of the target user using the electric water boiler solely by relying on a change in the actual operating current value when the electric water boiler is operated to dispense water. Therefore, the sound of water being dispensed out of the electric water boiler (i.e., the audio feature data) may assist in determining the usage behavior related to the electric water boiler. When the behavior in using the electrical appliance 200 is determined to be abnormal, the processing unit 23 sends the warning message to the user end device 300 that is related to the target user to notify relevant people such as friends and families of the target user, emergency contact persons or staff at nursing institutions of the target user in order for them to provide follow-up assistance and treatment.

When the processing unit 23 determines that the event data matches with one of the behavioral features, such a behavior in using the electrical appliance 200 will thus be determined to be normal, and the processing unit 23 will not send the warning message to the user end device 300.

In this embodiment, the processing module 16 of the electrical socket device 1 may further determine whether the electrical appliance 200 is operating in a normal condition or an abnormal condition based on the current feature data, the current detection result and the audio feature data. When the processing module 16 determines that the electrical appliance 200 is operating in the abnormal condition, the processing module 16 controls the output module 15 to generate a warning output that indicates the abnormal condition (e.g., flashing by the LED or beeping by the buzzer). In some embodiments, the processing module 16 further controls the socket module 11 to terminate supply of electric power to the electrical appliance 200 when determining that the electrical appliance 200 is operating in the abnormal condition. In particular, when the processing module 16 determines that the actual operating current value included in the current detection result exceeds the reference operating current range of the electrical appliance 200 included in the current feature data, the processing module 16 determines that the electrical appliance 200 is operating in the abnormal condition related to overcurrent. The processing module 16 may also determine that the electrical appliance 200 is operating in the abnormal condition when determining that the event corresponding with the audio feature data matches with any one of a plurality of predetermined events, and the sound amplitude exceeds a predetermined amplitude threshold or the usage duration exceeds a predetermined duration threshold or both. The plurality of predetermined events may include, for example, using a refrigerator, using an electric water boiler, using an air-conditioner machine, using a computer, etc. For example, assuming that the event corresponding with the audio feature data matches one of the predetermined events of using a refrigerator, when a compressor of the refrigerator is producing weird noises, which indicates that the refrigerator might be operating in the abnormal condition, the actual operating current value of the refrigerator may still be within the reference operating current range. At this time, the processing module 16 may receive the audio result from the audio receiving module 14, and the audio result may have the sound amplitude that exceeds the predetermined amplitude threshold due to the noises from the compressor, which causes the processing module 16 to determine that the refrigerator is operating in the abnormal condition. With this configuration, the processing module 16 may accurately determine that the electrical appliance 200 needs maintenance. It should be noted that, the aforementioned method is the processing module 16 determining that the electrical appliance 200 is operating in the abnormal condition based on a detection of abnormal amount of current (e.g., overcurrent) flowing through the electrical appliance 200 or a reception of abnormal sound (e.g., the electrical appliance 200 producing weird noise) by the audio receiving module 14, whereas step S05 is the processing unit 23 using the behavioral feature recognition model to determine whether an event data matches with one of the behavioral features, so as to determine whether there is abnormality in the usage behavior of the target user using the electrical appliance 200 within each specific time period, and to derive correspondingly a life routine of the target user in the house.

In sum, the electrical socket device 1 continues sending, to the management server 2, event data that is related to usage of the electrical appliance 200 connected thereto, and the management server 2 uses the behavioral feature recognition model to determine whether the event data thus received matches one of the behavioral features so as to predict whether the behavior of the target user using the electrical appliance 200 is normal (i.e., predicting whether the life routine of the target user is normal). Therefore, an objective of this disclosure of monitoring the life routine of the target living in the house while at the same time taking into account the privacy of the target user can be achieved; that is, intervention in the life of the target user may happen only when the safety or health of the target user is compromised, thereby allowing the target user to live more self-sufficiently. Furthermore, the processing unit 23 stores the event data in the database 21 as part of the service record data, so that the processing unit 23 may update the behavioral feature recognition model in the predetermined period, and thus the processing unit 23 may be more accurate in determining whether the event data matches with one of the behavioral features.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A system for monitoring usage of an electrical appliance, comprising:
an electrical socket device including
a socket module adapted to be electrically connected to the electrical appliance, and operable to switch between a first state for permitting supply of electric power to the electrical appliance and a second state for terminating supply of electric power to the electrical appliance,
a storage module storing current feature data that is related to multiple reference values of an operating current of the electrical appliance, the reference values corresponding respectively to different operating modes of the electrical appliance,
a current detecting module electrically connected to said socket module, and configured to continuously detect a current flowing through the electrical appliance so as to generate a current detection result,
an audio receiving module for receiving sound at a site where the electrical appliance is disposed and generating an audio result based on the sound thus received, and
a processing module electrically connected to said socket module, said and configured to generate audio feature data based on the audio result, and to generate event data that is related to the usage of the electrical appliance based on the current feature data, the current detection result and the audio feature data; and
a management server including
a database storing user data that is related to a user at the site, appliance data that is related to the electrical appliance, and service record data that is related to historical usage of the electrical appliance,
a storage unit storing a behavioral feature recognition model that is configured to recognize multiple behavioral features related to behaviors of the user using the electrical appliance, wherein the behavioral features and the behavioral feature recognition model are derived and established by using a first machine learning algorithm to analyze the user data and the service record data based on multiple feature parameters that are each related to the user, the electrical appliance, and an environment where the electrical appliance is disposed, and
a processing unit communicatively connected to said processing module, and electrically connected to said database and said storage unit,
wherein said processing module transmits the event data to said processing unit, and said processing unit uses the behavioral feature recognition model to determine whether the event data received from said processing module matches one of the behavioral features, and sends a warning message to a user end device that is related to the user upon determining that the event data does not match any of the behavioral features.

2. The system as claimed in claim 1, wherein said processing unit further stores the event data in said database as a part of the service record data upon receipt of the event data,
determines, based on the event data and the appliance data, whether operating current information that is related to the operating current of the electrical appliance needs to be adjusted,
generates, upon determining that the operating current information needs to be adjusted, current feature adjustment data that indicates adjustment of the operating current information, and
transmits the current feature adjustment data to said storage module of said electrical socket device in order to update the current feature data stored in said storage module.

3. The system as claimed in claim 1, wherein said storage module of said electrical socket device further stores an audio feature recognition model that is configured to recognize multiple audio features;
wherein the audio features and the audio feature recognition model are derived and established by using a second machine learning algorithm to analyze the audio result based on multiple audio parameters that are each related to the environment where the electrical socket device is disposed; and
wherein said processing module uses the audio feature recognition model to determine which of the audio features that the audio result generated by said audio receiving module matches, and generates the audio feature data based on the audio result that matches any of the audio features.

4. The system as claimed in claim 1, wherein said electrical socket device further includes an output module that is electrically connected to said processing module; and
wherein said processing module of said electrical socket device determines whether the electrical appliance is operating in one of a normal condition and an abnormal condition based on the current feature data, the current detection result and the audio feature data, and upon determining that the electrical appliance is operating in the abnormal condition, makes said output module to execute one of a first response of generating a warning output that indicates the abnormal condition, and a second response of controlling said socket module to terminate supply of electric power to the electrical appliance.

5. A method for monitoring usage of an electrical appliance, said method being implemented by a system that includes an electrical socket device and a management server,
the electrical socket device storing current feature data that is related to multiple reference values of an operating current of the electrical appliance, the reference values corresponding respectively to different operating modes of the electrical appliance,
the management server storing user data that is related to a user at a site where the electrical appliance is disposed, appliance data that is related to the electrical appliance, service record data that is related to historical usage of the electrical appliance, and a behavioral feature recognition model that is configured to recognize multiple behavioral features related to behaviors of the user using the electrical appliance,
said method comprising:
by the electrical socket device, continuously detecting a current flowing through the electrical appliance to generate a current detection result, receiving sound at the site, and generating an audio result based on the sound thus received;
by the electrical socket device, generating audio feature data based on the audio result, generating event data related to the usage of the electrical appliance based on the current feature data, the current detection result and the audio feature data, and transmitting the event data to the management server;
by the management server, using the behavioral feature recognition model to determine whether the event data received from the electrical socket device matches one of the behavioral features; and
by the management server, sending a warning message to a user end device that is related to the user in response to determining that the event data does not match any of the behavioral features.

6. The method as claimed in claim 5, further comprising:
by the management server, storing the event data as a part of the service record data upon receipt of the event data from the electrical socket device;
by the management server, determining, based on the event data and the appliance data, whether operating current information that is related to the operating current of the electrical appliance needs to be adjusted;
by the management server, in response to determining that the operating current information needs to be adjusted, generating current feature adjustment data that indicates adjustment of the operating current information, and transmitting the current feature adjustment data to the electrical socket device; and
by the electrical socket device, upon receipt of the current feature adjustment data from the management server, using the current feature adjustment data to update the current feature data.

7. The method as claimed in claim 5, the electrical socket device further storing an audio feature recognition model that is configured to recognize multiple audio features, the method further comprising:
by the electrical socket device, storing an audio feature recognition model that is configured to recognize multiple audio features, using a second machine learning algorithm to analyze the audio detection result based on multiple audio parameters that are each related to the environment where the electrical appliance is disposed, so as to derive the audio features and establish the audio feature recognition model,
by the electrical socket device, using the audio feature recognition model to determine which among the audio features that the audio detection result matches with, and generating the audio feature data based on the audio detection result that matches with any of the audio features.

8. The method as claimed in claim 5, further comprising:
by the electrical socket device, determining whether the electrical appliance operates in one of a normal condition and an abnormal condition based on the current feature data, the current detection result and the audio feature data; and
by the electrical socket device, in response to determining that the electrical appliance operates in the abnormal condition, executing one of a first response of generating a warning output that indicates the abnormal condition, and a second response of terminating supply of electric power to the electrical appliance.

9. The method as claimed in claim 5, further comprising:
by the management server, using a machine learning algorithm to analyze the user data and the service record data based on multiple feature parameters that are each related to the user, the electrical appliance, and an environment where the electrical appliance is disposed, so as to derive the behavioral features in relation to behaviors of the user using the electrical appliance at the site and to establish the behavioral feature recognition model.

10. An electrical socket device to be used in a system for monitoring usage of an electrical appliance, the system including a management server, said electrical socket device comprising:
a socket module adapted to be electrically connected to the electrical appliance, and operable to switch between a first state for permitting supply of electric power to the electrical appliance and a second state for terminating supply of electric power to the electrical appliance;
a storage module storing current feature data that is related to multiple reference values of an operating current of the electrical appliance, the reference values corresponding respectively to different operating modes of the electrical appliance;
a current detecting module electrically connected to said socket module, and configured to continuously detect a current flowing through the electrical appliance so as to generate a current detection result;
an audio receiving module for receiving sound at a site where the electrical appliance is disposed and generating an audio result based on the sound thus received; and
a processing module electrically connected to said socket module, said storage module, said current detecting module and said audio receiving module, and configured to generate audio feature data based on the audio result, generate event data that is related to the usage of the electrical appliance based on the current feature data, the current detection result and the audio feature data, and transmit the event data to the management server.

11. The electrical socket device as claimed in claim 10, wherein said storage module further stores an audio feature recognition model that is configured to recognize multiple audio features;
wherein the audio features and the audio feature recognition model are derived and established by using a second machine learning algorithm to analyze the audio detection result based on multiple audio parameters that are each related to the environment where the electrical appliance is disposed; and
wherein said processing module uses the audio feature recognition model to determine which of the audio features that the audio result generated by said audio receiving module matches, and generates the audio feature data based on the audio result that matches any of the audio features.

12. The electrical socket device as claimed in claim 10, further comprising an output module that is electrically connected to said processing module,
wherein said processing module determines whether said electrical appliance is operating in one of a normal condition and an abnormal condition based on the current feature data, the current detection result and the audio feature data, and upon determining that the electrical appliance is operating in the abnormal condition, makes said output module to execute one of a first response of generating a warning output that indicates the abnormal condition, and a second response of controlling said socket module to terminate supply of electric power to the electrical appliance.
